(19) United States
(12) Patent Application Publication
(10) Pub. No.: US 2007/0051830 A1
(43) Pub. Date: Mar. 8, 2007

(54) Method and Apparatus For Sprayer Guard

(76) Inventor: Vincent Cullotta, Des Plaines, IL (US)

Correspondence Address: MCANDREWS HELD & MALLOY, LTD, 500 WEST MADISON STREET, SUITE 3400, CHICAGO, IL, 60661, US

(21) Appl. No.: 11/469,559

(22) Filed: Sep. 1, 2006

Related U.S. Application Data
(60) Provisional application No. 60/713,702, filed on Sep. 2, 2005.

(51) Int. Cl. B05B 15/04

(52) U.S. Cl. 239/288.3; 239/526

(57) ABSTRACT

Certain embodiments of the present invention provide a guard apparatus for impeding a motion of an actuator of a sprayer for spraying fluids, the guard comprising: at least one lateral portion having a front and a back; a front portion connected to the front of said at least one lateral portion; and a rear portion connected to the rear of said at least one lateral portion, wherein the guard is capable of engaging with the sprayer to substantially impede a motion of the actuator to prevent a substantial amount of fluid flow from the sprayer. In an embodiment, the apparatus further comprises a fastener for fastening the guard to the sprayer. In an embodiment, said fastener further comprises at least one of: a screw, and a bolt. In an embodiment, said rear portion further comprises a fastening hole for accommodating said fastener. In an embodiment, the sprayer further includes a fastening hole for receiving said fastener. In an embodiment, said fastener is configured to allow a specialized tool to facilitate fastening of the sprayer and the guard. In an embodiment, said front portion is capable of substantially impeding said motion of the actuator. In an embodiment, the guard is capable of rotating about a recessed portion of the sprayer capable of receiving said front portion of the guard. In an embodiment, said front portion comprises an aperture capable of receiving the actuator.

This application claims priority to U.S. Provisional Patent Application No. 60/713,702, filed on Sep. 2, 2005, which is herein incorporated by reference.

### BACKGROUND OF THE INVENTION

Generally, this application relates to improvements for discouraging fluid discharge from a sprayer. More specifically, this application relates to provision of a guard and/or obstruction device for limiting the motion of an actuator of a sprayer to discourage fluid discharge from the sprayer. It should be understood that a fluid may consist either primarily of liquid or primarily of gas. Some fluids may be stored as primarily liquid, and dispensed as primarily gas.

Fluid sprayers are well-known, and may be used for a variety of fluids and/or products. For example, fluid sprayers are used for spraying and dispensing surface cleansers, glass cleansers, disinfectants, and anti-dust fluids. For a variety of reasons, it may be desirable to prevent unauthorized and/or unintentional discharge of fluids from sprayers. For example, some of the fluids used in conjunction with fluid sprayers may be relatively costly, or may have potentially harmful properties if incorrectly used. For example, a fluid may be an irritant, and should only be used in a well-ventilated area. While fluids, such as household cleaning fluids, should be used according to labeling instructions, there are some people who may intentionally misuse and/or abuse the fluids.

Conventional sprayers may incorporate safety and/or protective designs. For example, spray cleaners may have a tamper-evident tab that indicates to a consumer that the product has not been tampered with. However, the tamper-evident tab must be removed before using the product. Once the tab has been removed, there may be no way to reattach the tab to detect and/or prevent unauthorized and/or unintentional use of the product.

Thus, there is a need for methods and apparatuses that prevent unauthorized and/or unintentional use of fluids through a sprayer. Additionally, there is a need for methods and apparatuses that incorporate repeatably usable safety designs. There is a need for methods and apparatuses that provide such improvements in a relatively simple and cost-effective manner.

### SUMMARY OF THE INVENTION

Certain embodiments of the present invention provide a guard apparatus for impeding a motion of an actuator of a sprayer for spraying fluids, the guard comprising: at least one lateral portion having a front and a back; a front portion connected to the front of said at least one lateral portion; and a rear portion connected to the rear of said at least one lateral portion, wherein the guard is capable of engaging with the sprayer to substantially impede a motion of the actuator to prevent a substantial amount of fluid flow from the sprayer. In an embodiment, the apparatus further comprises a fastener for fastening the guard to the sprayer. In an embodiment, said fastener further comprises at least one of: a screw, and a bolt. In an embodiment, said rear portion further comprises a fastening hole for accommodating said fastener. In an embodiment, the sprayer further includes a fastening hole for receiving said fastener. In an embodiment, said fastener is configured to allow a specialized tool to facilitate fastening of the sprayer and the guard. In an embodiment, said front portion is capable of substantially impeding said motion of the actuator. In an embodiment, the guard is capable of rotating about a recessed portion of the sprayer capable of receiving said front portion of the guard. In an embodiment, said front portion comprises an aperture capable of receiving the actuator.

Certain embodiments of the present invention provide an apparatus for a guard for preventing a substantial fluid flow from a sprayer comprising: a front portion; and a rear portion connected to said front portion by at least one lateral portion, wherein said front portion is capable of impeding a motion of an actuator of the sprayer to prevent substantial fluid flow. In an embodiment, the guard is removably engagable from the sprayer. In an embodiment, the apparatus further includes a fastener for fastening the guard to the sprayer. In an embodiment, said fastener comprises at least one of: a screw and a bolt. In an embodiment, said fastener is receivable by a threaded portion of the sprayer. In an embodiment, said fastener is receivable by a threaded portion of said rear portion of the guard.

Certain embodiments of the present invention provide a system for permitting a user to control discharge of fluids comprising: a sprayer having an actuator for actuating a flow of fluids, said actuator having a motion capable of causing said flow; and a guard for engaging with the sprayer, said guard further comprising at least one lateral portion, a front portion, and a rear portion, wherein said guard is capable of engaging with said sprayer such that said front portion impedes said motion of said actuator. In an embodiment, the system further includes a fastener for removably fastening said guard to said sprayer. In an embodiment, said rear portion of said guard comprises a fastening hole for receiving said fastener. In an embodiment, said sprayer comprises a fastening hole for receiving said fastener. In an embodiment, said guard and said sprayer are capable of being be repeatedly fastened.

### BRIEF DESCRIPTION OF SEVERAL VIEWS OF THE DRAWINGS

FIG. 1 shows a guard according to an embodiment of the present application.

FIG. 2 shows a guard and a sprayer according to an embodiment of the present application.

FIG. 3 shows a guard according to an embodiment of the present application.

FIG. 4 shows a guard according to an embodiment of the present application.

The foregoing summary, as well as the following detailed description of certain embodiments of the present application, will be better understood when read in conjunction with the appended drawings. For the purpose of illustrating the application, certain embodiments are shown in the drawings. It should be understood, however, that the present application is not limited to the arrangements and instrumentality shown in the attached drawings.

### DETAILED DESCRIPTION OF THE INVENTION

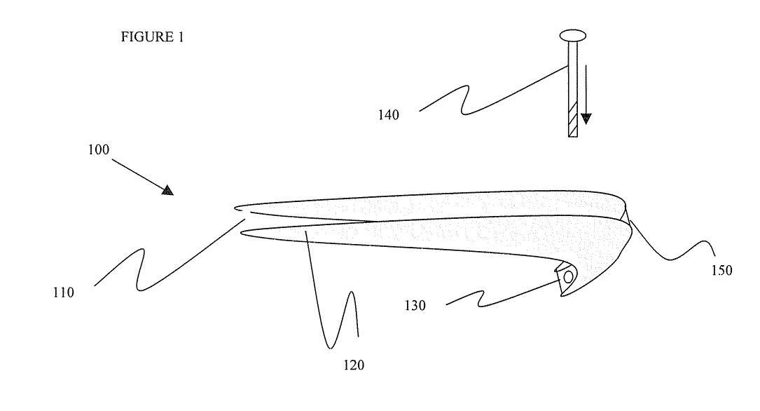

FIG. 1 shows a guard 100 according to an embodiment of the present application. A guard 100 may be formed from two lateral portions 120 connected at the front and back. Each lateral portion 120 may have a hook-type shape at the rear. The hook-type shape may facilitate engagement and disengagement of the guard 100 from a sprayer. The lateral portions 120 may also taper to a narrower point at the front.

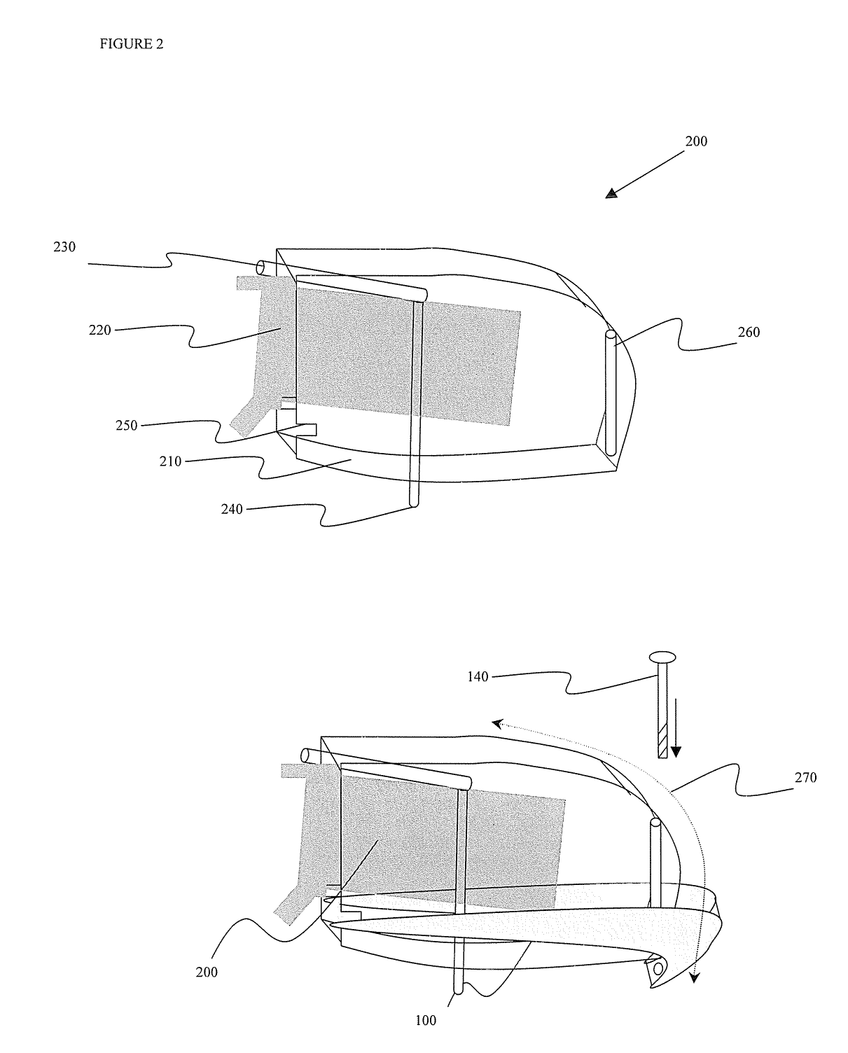

The lateral portions 120 may be connected at the front by a front portion 110. The front portion 110 may include an interference portion. The front portion 110 may facilitate rotation of the guard 100 about the front portion 110. For example, a portion of the front portion, such as the interference portion, may be substantially rounded. The front portion 110 and/or the interference portion may be configured to fit in a recessed portion underneath an actuator, as will be discussed in greater detail in conjunction with FIG. 2. The lateral portions 120 may be also connected at the rear by a rear portion 150. For example, rear portion 150 may connect the lateral portions 120 along the rear edge of the hook-type shape. The rear portion may have a fastening hole 130 capable of receiving a fastener 140. The fastener 140 may be a screw or bolt, for example. In an embodiment, the fastener may be a ¾ inch screw, and fastening hole 130 may be configured to receive threads of the screw to form a connection. The fastener 140 may require a tool, such as a screwdriver, to connect and disconnect the fastener 140 from the rear portion 120 of the guard 100. In an embodiment, the fastener 140 may be require a specialized tool, such as a driver with an uncommon or a unique driving head, to engage and disengage the fastener 140. Fastener 140 may be formed form plastic and/or metal, and/or other suitable materials.

If two lateral portions 120, a rear portion 150, and a front portion 110 are provided, then the guard 100 may form a loop as viewed from the top or bottom of the guard 100. However, a guard 100 may also form an incomplete loop, and may resemble, for example, the letter “C” as viewed from the top or bottom. For example, a guard 100 may be formed with one lateral portion 120, front portion 110 and a rear portion 150. A guard 100 having an incomplete loop may also be formed by one complete lateral portion 120, one partial lateral portion 120, a rear portion 150, and a front portion 110.

The guard 100 may be formed as an assembly of the various portions, or the guard 100 may be a single piece plus the fastener 140. For example, the guard 100 may be formed by injection molding, or by other suitable processes. The guard 100 may be formed from a primarily plastic material. The guard 100 may have rounded edges, rather than the squared edges shown in FIG. 1. The guard 100 may be designed to be thicker or thinner at various portions, depending on the desired effect and the configuration of the sprayer. The guard 100 may appear substantially rectangular from a top or bottom view, or it may appear oblong, elliptical, trapezoidal, or the like. The hook-type shape of the guard 100 shown in FIG. I is only for illustrative purposes, and any of a variety of shapes and sizes for this aspect of the guard 100 may be substituted.

FIG. 2 shows a guard 100 and a sprayer 200 according to an embodiment of the present application. A sprayer 200 is shown by itself, and with a guard 100. A sprayer 200 may include a housing 210, an actuator 220, a nozzle 230, a valve 240, a front recessed portion 250 and a sprayer fastening hole 260. A sprayer 200 may be any of a variety of types of sprayers. For example, a sprayer 200 may be an aerosol sprayer, a hose sprayer, a tank sprayer, a trombone sprayer, a hand pump sprayer, a spray dome, a finger pump sprayer, or the like. A sprayer 200 may be attachable to a container that houses fluid (not shown). For example, a sprayer 200 may be attachable to a canister of spray duster fluid. Fluids may include liquids, gasses, aerosols, propellants, and the like. Fluids may change states during, or after the spraying process. For example, fluids may be stored in a canister as a liquid, but may become gaseous upon decompression during the spraying process.

The sprayer housing 210 may be generally hollow, and may, for example include venting or other openings. The housing 210 may be configured to accept additional components, or portions thereof. For example, the housing 210 may be configured to accept a portion of the actuator 220. The housing 210 may also include a front recessed portion 250. Additionally, the rear of the housing 210 may include a sprayer fastening hole 260.

An actuator 220 may be rotatably connected to the housing 210. The actuator 220 may be connected and/or configured so that it is moveable, for example, in a rotational direction around the connection of the actuator 220 to the housing 210. The actuator 220 may be one or more pieces. An actuator may include a lever, a button, a trigger, and/or the like.

The actuator 220 may be configured to move a valve 240. When external pressure, such as a squeezing finger, is applied to the actuator 220, the actuator 220 may move in a rotational direction. Alternatively, the actuator 220 may be configured to move in a translational direction (i.e. not rotational) in response to external pressure. As another alternative, the actuator 220 may be configured to move in a combination of rotational and translational directions in response to external pressure. The movement of the actuator 220 may then, in turn, cause movement of the valve 240. The valve 240 may be moved in a direction such that fluid contained in a separate container (not shown) may flow through the valve 240. If fluid is already flowing through the valve 240, the above-described actuator 220 motion may cause fluid flow to increase through the valve 240. The fluid may flow through the valve 240 and out of the nozzle 230. A spring (not shown) may also be provided as part of the sprayer 200. The function of the spring may be to return the actuator 220 to an “OFF” position when external pressure is removed from the actuator 220. When the actuator 220 returns to an “OFF” position, the valve 240 may also be caused to move. The resulting movement of the valve 240 may result in a cessation or a reduction of fluid flow through the valve 240.

Also shown in FIG. 2 is a combination of a sprayer 200 and a guard 100. The guard 100 may be engaged with the sprayer 200 in the following manner. The front portion 110 of the guard 100 may be moved into the front recessed portion 250 of the sprayer 200. The guard then may be moved in a rotational direction 270 clockwise (as shown) around the sprayer 200. Because the guard 100 may as a loop, or a portion thereof, the guard 100 may rotate without substantial impediment around the sprayer 200. The rear portion 120 of the guard 100 may be configured such that at a point of rotation of the guard 100 around the sprayer 200, the guard will rest on a rear portion of the housing 210. It may rest without substantial movement, because of friction between the rear portion 120 of the guard and the housing 210. Although friction may provide some stability of movement of the guard 100 with respect to the sprayer 200, it may still be possible to easily move or rotate the guard 100 by applying specific pressure to the guard 100 and/or sprayer 200 to overcome the friction. The frictionally resting position (not shown) may be useful for temporary storage of the guard. For example, a sprayer 200 may be sold with a guard 100 in this position.

The guard 100 may further be rotated clockwise into a position shown in FIG. 2. As shown, the fastening hole 130 of the guard 100 substantially lines up below the sprayer fastening hole 260 of the sprayer 200. The hook-type shape of the guard 100 may facilitate this placement of the guard 100 with respect to the sprayer 200 as shown. Once the guard 100 is substantially in the position with the fastening hole 130 lined up with the sprayer fastening hole 260 of the sprayer, a fastener 140 may be inserted. As described, a fastener 140 may be a screw with threads. The fastener 140 may be inserted through the sprayer fastening hole 260 of the sprayer 200 and threaded into the fastening hole 130 of the guard. The fastening hole 130 of the guard 100 may have corresponding threading to assist mating with the fastener 140. In an embodiment, the fastener 140 requires a specialized tool (not shown) for fastening. For example, the fastener 140 may require a unique or uncommon driver head to fasten and unfasten the fastener 140. Once fastened, the guard 100 may be substantially connected with the sprayer 200.

When properly situated, the front portion 110 of the guard 100, or a portion thereof such as the interference portion, may impede motion of the actuator 220 of the sprayer 200. For example, if application of external pressure to an actuator 220 causes a general downward motion of the actuator 220, then the front portion 110 may impede and/or limit the motion of the actuator 220. The motion of the actuator 220 may be impeded such that fluid cannot substantially flow through the valve 240 without removing or damaging the guard 100. While some actuator 220 motion may be possible, it may be insufficient to cause fluid flow. Alternatively, the limited motion of the actuator 220 may only cause a relatively low amount of fluid to flow through the valve 240.

To remove the guard 100, the fastener 140 (if provided) may be removed. Again, it may require a specialized tool to remove the fastener 140, if desired. The guard 100 may then be rotated in a rotational direction 270 counterclockwise (as shown). The fastener may be stored in either the sprayer fastening hole 260 of the sprayer 200 or the fastening hole 130 of the guard 100, or in some other location. Once the guard 100 has been disconnected and removed from the sprayer 200, the actuator 220 may be moved to cause substantial fluid flow through the valve 240.

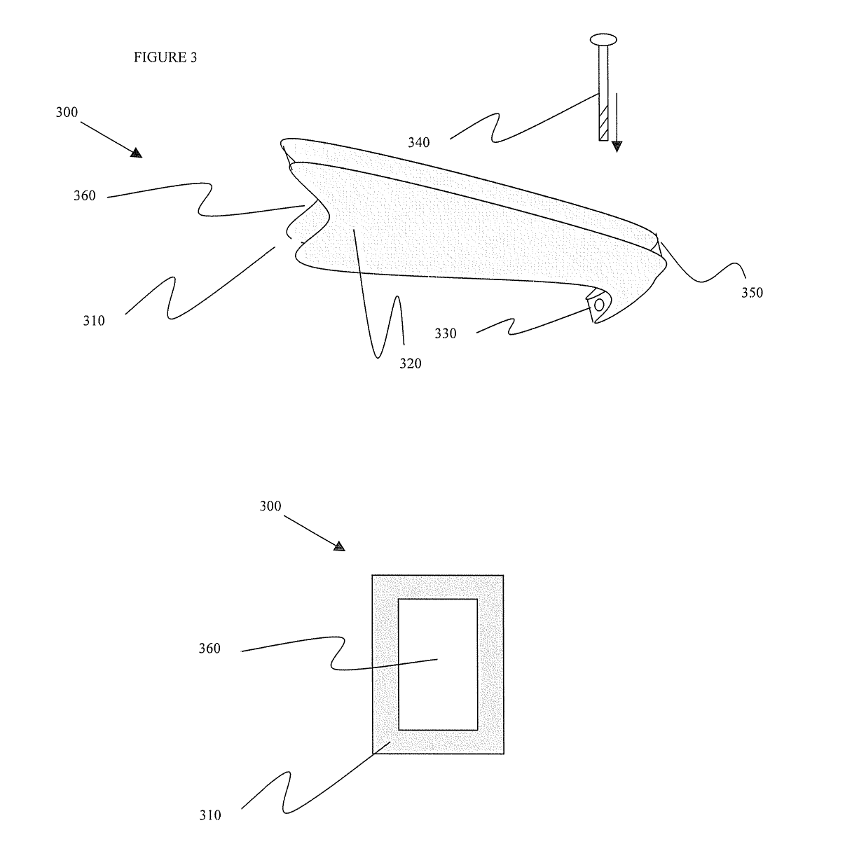

FIG. 3 shows a guard 300 according to an embodiment of the present application. Two views are shown in FIG. 3: a side view, and a front view of guard 300. Guard 300 may in many respects be similar to guard 100 described above. Additionally, guard 300 may interface and connect with the sprayer 200 in a similar fashion as described for guard 100. A guard 300 may be formed from two lateral portions 320 connected at the front and back. Each lateral portion 320 may have a hook-type shape at the rear. The hook-type shape may facilitate engagement and disengagement of the guard 300 from a sprayer, such as sprayer 200. The lateral portions 320 may also taper to become narrower towards the rear.

The lateral portions 320 may be connected at the front by a front portion 310. As shown in the front view of guard 300, the front portion 310 may include an aperture 360. The aperture 360 may facilitate receiving and/or interfacing of the guard 300 with a sprayer, such as sprayer 200. The aperture 360 may be configured to accept or receive a portion of an actuator, such as actuator 220. The front portion 310 may also include an interference portion. The interference portion of guard 300 may be configured to fit in, for example, a front recessed portion 250 of sprayer 200. The interference portion may facilitate rotation of the guard 300 about the interference portion. For example, the interference portion may be rounded, or substantially cylindrical. When situated properly, the interference portion may limit and/or impede the motion of a sprayer actuator, such as actuator 220.

The lateral portions 320 may be also connected at the rear by a rear portion 350. For example, rear portion 350 may connect the lateral portions 320 along the rear edge of the hook-type shape. The rear portion may have a fastening hole 330 capable of receiving a fastener 340. The fastener 340 may be a screw or bolt, for example. In an embodiment, the fastener may be a 3/4 inch screw, and fastening hole 330 may be configured to receive threads of the screw to form a connection. The fastener 340 may require a tool, such as a screwdriver, to connect and disconnect the fastener 340 from the rear portion 320 of the guard 300. In an embodiment, the fastener 340 may be require a specialized tool, such as a driver with an uncommon or a unique driving head, to engage and disengage the fastener 340. Fastener 340 may be formed form plastic and/or metal, and/or other suitable materials.

If two lateral portions 320, a rear portion 350, and a front portion 310 are provided, then the guard 300 may form a loop as viewed from the top or bottom of the guard 300. However, a guard 300 may also form an incomplete loop, and may resemble, for example, the letter “C” as viewed from the top or bottom. For example, a guard 300 may be formed with one lateral portion 320, front portion 310 and a rear portion 350. A guard 300 having an incomplete loop may also be formed by one complete lateral portion 320, one partial lateral portion 320, a rear portion 350, and a front portion 310.

The guard 300 may be formed as an assembly of the various portions, or the guard 300 may be a single piece plus the fastener 340. For example, the guard 300 may be formed by injection molding, or by other suitable processes. The guard 300 may be formed from a primarily plastic material. The guard 300 may have rounded edges, rather than the squared edges shown in FIG. 3. The guard 300 may be designed to be thicker or thinner at various portions, depending on the desired effect and the configuration of the sprayer. The guard 300 may appear substantially rectangular from a top or bottom view, or it may appear oblong, elliptical, trapezoidal, or the like. The hook-type shape of the guard 300 shown in FIG. 1 is only for illustrative purposes, and any of a variety of shapes and sizes for this aspect of the guard 300 may be substituted.

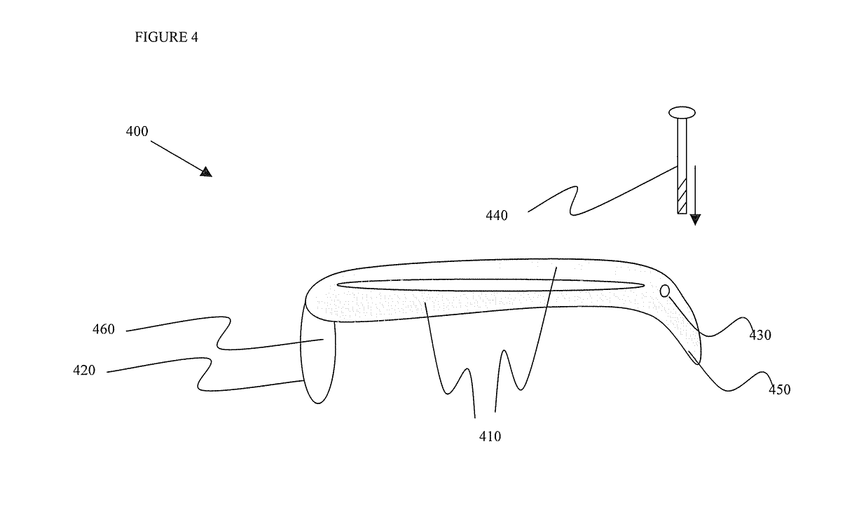

FIG. 4 shows a guard 400 according to an embodiment of the present application. Guard 400 may be similar to guards 100 and 300. Guard 400 may include at least one lateral portion 410, a front portion 420, a guard fastening hole 430, a fastening member 440, and a rear portion 450. One or more lateral portions 410 may be configured to rest like a hat, or a cap on top of a sprayer, such as sprayer 200. One or more lateral portions 410 may include a concave, or a semi-hollowed portion on the underside of each lateral portion 410, or two or more lateral portions 410 in combination. The underside of the one or more lateral portions 410 may be configured to substantially accept or interface with contours of a top portion of a sprayer, such as sprayer 200.

Guard 400 may further include a front portion 420. The front portion 420 may be a loop, or some variation or portion thereof. The front portion 420 may have an aperture 460. The aperture 460 may be configured to receive and/or accept a portion of an actuator, such as actuator 220. The front portion 420 may include an interference portion, which may be configured to be situated below an actuator, such as actuator 220, when one or more lateral portions 410 rest on a sprayer.

Guard 400 may include a rear portion 450 connected to one or more lateral portions 410. The rear portion 450 may include a guard fastening hole 430. When one or more lateral portions 410 of guard 400 are resting on top of a sprayer, such as sprayer 200, guard fastening hole 430 of guard 400 may substantially align with a sprayer fastening hole, such as sprayer fastening hole 260. Guard fastening hole 430 may be configured to receive a fastener 440. A fastener 440 may be inserted through guard fastening hole 430, and further inserted through a fastening hole of a sprayer, such as sprayer fastening hole 260. Fastener 440 may be similar to fasteners 140 and 340. For example, fastener 440 may be a screw, and may require a specialized driver for fastening and unfastening. Fastener 440 may be a screw having threads that engage with complementary threads in a fastening hole of a sprayer, such as sprayer fastening hole 260. As an alternative, a fastening hole of a sprayer, such as sprayer fastening hole 260, may not be threaded, or may have an alternative connection design. As another alternative, it may be relatively easy to drive a fastener 440 having appropriate threading into a housing of a sprayer, such as housing 210, if the housing is made of a relatively soft and/or flexible material such as polyvinylchloride (PVC). As another alternative, a sprayer fastening hole, such as sprayer fastening hole 260, may serve as a type of pilot hole for fastener 440. Fastener 440 may be formed form plastic, metal, and/or other suitable materials. In this manner, the rear portion 450 of guard 400 may be connected to a sprayer.

Once the guard 400 is in place, the front portion 420, or a portion thereof such as the interference portion, may limit and/or impede a motion of an actuator, such as actuator 220. The front portion 420 of the guard 400 may impede motion of the actuator of the sprayer. For example, if application of pressure to an actuator causes a general downward motion, then the interference portion of the front portion 420 may impede and/or limit a rotational and/or translational motion of the actuator. Other portions of the front portion 420, such as the top portion, may also impede and/or limit a motion of the actuator. The motion of the actuator may be impeded such that fluid cannot substantially flow through the valve without removing or damaging the guard 400. While some actuator motion may be possible, it may be insufficient to cause fluid flow. Alternatively, the limited motion of the actuator may only cause a relatively low amount of fluid to flow through the valve.

In addition to guards, it may also be possible to impede the motion of the actuator with an obstruction device or portion. An obstruction device may be molded as an integral portion of a sprayer (e.g. sprayer 200). For example, an obstruction device may be molded into the housing of a sprayer (e.g. 210) or some other portion of a sprayer. An obstruction device may be moveable with respect to what it is molded to, for example. An obstruction device may be further moveable with respect to the actuator, for example. An obstruction device may be moveable to impede motion of an actuator and to allow substantial motion in an actuator, for example. An obstruction device may be molded to another portion and moveable through a hinge, spring, or other motion-permitting portion, for example. Movement of the obstruction device may involve rotation, folding, sliding or other types of motion, for example.

Thus, embodiments of the present application provide methods and apparatuses for preventing unauthorized and/or unintentional use of fluids through a sprayer. Additionally, embodiments of the present application provide methods and apparatuses for repeatedly usable safety designs. Moreover, embodiments of the present application provide methods and apparatuses for provision of such improvements in a relatively simple and cost-effective manner.

While the application has been described with reference to certain embodiments, it will be understood by those skilled in the art that various changes may be made and equivalents may be substituted without departing from the scope of the application. In addition, many modifications may be made to adapt a particular situation or material to the teachings of the application without departing from its scope. Therefore, it is intended that the application not be limited to the particular embodiment disclosed, but that the application will include all embodiments falling within the scope of the appended claims.

What is claimed is:

1. A guard apparatus for impeding a motion of an actuator of a sprayer for spraying fluids, the guard comprising:
at least one lateral portion having a front and a back;
a front portion connected to the front of said at least one lateral portion; and
a rear portion connected to the rear of said at least one lateral portion,
wherein the guard is capable of engaging with the sprayer to substantially impede a motion of the actuator to prevent a substantial amount of fluid flow from the sprayer.

2. The apparatus of claim 1 further comprising a fastener for fastening the guard to the sprayer.

3. The apparatus of claim 2, wherein said fastener comprises at least one of: a screw, and a bolt.

4. The apparatus of claim 2, wherein said rear portion further comprises a fastening hole for accommodating said fastener.

5. The apparatus of claim 2, wherein the sprayer further comprises a fastening hole for receiving said fastener.

6. The apparatus of claim 2, wherein said fastener is configured to allow a specialized tool to facilitate fastening of the sprayer and the guard.

7. The apparatus of claim 1, wherein said front portion is capable of substantially impeding said motion of the actuator.

8. The apparatus of claim 1, wherein the guard is capable of rotating about a recessed portion of the sprayer capable of receiving said front portion of the guard.

9. The apparatus of claim 1, wherein said front portion comprises an aperture capable of receiving the actuator.

10. A apparatus for a guard for preventing a substantial fluid flow from a sprayer comprising:
a front portion; and
a rear portion connected to said front portion by at least one lateral portion,
wherein said front portion is capable of impeding a motion of an actuator of the sprayer to prevent substantial fluid flow.

11. The apparatus of claim 10, wherein the guard is removably engagable from the sprayer.

12. The apparatus of claim 11 further comprising a fastener for fastening the guard to the sprayer.

13. The apparatus of claim 12, wherein said fastener comprises at least one of: a screw and a bolt.

14. The apparatus of claim 12, wherein said fastener is receivable by a threaded portion of the sprayer.

15. The apparatus of claim 12, wherein said fastener is receivable by a threaded portion of said rear portion of the guard.

16. A system for permitting a user to control discharge of fluids comprising:
a sprayer having an actuator for actuating a flow of fluids, said actuator having a motion capable of causing said flow; and
a guard for engaging with the sprayer, said guard further comprising at least one lateral portion, a front portion, and a rear portion,
wherein said guard is capable of engaging with said sprayer such that said front portion impedes said motion of said actuator.

17. The system of claim 16 further comprising a fastener for removably fastening said guard to said sprayer.

18. The system of claim 17, wherein said rear portion of said guard comprises a fastening hole for receiving said fastener.

19. The system of claim 17, wherein said sprayer comprises a fastening hole for receiving said fastener.

20. The system of claim 17, wherein said guard and said sprayer are capable of being repeatedly fastened.
